(19) United States
(12) Patent Application Publication
(10) Pub. No.: US 2010/0178959 A1
(43) Pub. Date: Jul. 15, 2010

(54) RETRACTABLE SPEAKER EAR PIECE UNIT AND PHONE WATCH CONTAINING THE SAME

(76) Inventor: Peter Alan Fish, Killara (AU)

Correspondence Address: BAKER & MCKENZIE LLP, 711 Louisiana, Suite 3400, HOUSTON, TX, 77002, US

(21) Appl. No.: 12/684,265

(22) Filed: Jan. 8, 2010

(30) Foreign Application Priority Data
Jan. 15, 2009 (AU) 2009100022
Aug. 25, 2009 (CN) 200930205752.1
Dec. 21, 2009 (CN) 200910259364.0

(51) Int. Cl. H04M 1/00

(52) U.S. Cl. 455/569.1

(57) ABSTRACT

Retractable speaker ear piece unit and phone watch containing the same. Particularly, a retractable speaker ear piece unit, for using in an electronic device, the retractable speaker ear piece unit comprising a housing; a speaker ear piece positioned outside the housing; a retractable cord mechanism accommodated in the housing; and a cord, connecting the speaker ear piece and the retractable cord mechanism, which may be extended from or retracted to the retractable cord mechanism. The retractable speaker ear piece unit and the phone watch containing the retractable speaker ear piece unit are simple in structure, which facilitates modularization and easy manipulation.

### FIELD OF THE INVENTION

The present invention generally relates to speaker ear piece unit and phone watch, and more particularly to retractable speaker ear piece unit and phone watch containing the unit.

### BACKGROUND ARTS

Phone watches have become popular with the miniaturization of technology products, and several designs are available on the market.

The positive feature of a phone watch versus a hand held device is that the phone watch is hands free and always accessible on the users' wrist. However, the negative feature of the phone watch is that the user must incorporate a separate blue tooth ear piece or attach a fixed cord with ear plug for listening purpose. A loud speaker phone function is also an option, but this does not favor the privacy of a user. The problem with either of these designs is that they are uncomfortable for some users and the ear piece may often fall out. It is also not fashionable for many users.

### SUMMARY OF THE INVENTION

The present invention is directed to resolve above-mentioned problems by providing a retractable speaker ear piece unit and phone watch containing the unit.

The present invention provides a retractable speaker ear piece unit for using in an electronic device, the retractable speaker ear piece unit comprising: a housing; a speaker ear piece positioned outside the housing; a retractable cord mechanism accommodated in the housing; and a cord, connecting the speaker ear piece and the retractable cord mechanism, which may be extended from or retracted to the retractable cord mechanism.

According to one embodiment, the retractable cord mechanism may include a resilient element coupling with the cord. According to one embodiment, the housing may be the casing of the electronic device, or the casing of the electronic device may encompass the housing. The housing and the casing of the electronic device may be an integrally formed single component or two separable components.

According to one embodiment, the retractable speaker ear piece unit may further include a microphone device embedded in the housing. Simultaneously, the housing may have a sound pickup hole. The internal microphone device cooperates with the hole, so that the retractable speaker ear piece unit can also be used as a phone in a call.

The retractable speaker ear piece unit may further include a coupler positioned outside the housing for detachably coupling with the electronic device to establish a connection between the speaker ear piece unit and the electronic device. The coupler may include metal contactors and an elastic press switch, and when the coupler is coupled with the electronic device, the metal contactors are contacted and the elastic press switch is pressed, so as to establish the electric connection between the speaker ear piece and the electronic device.

The coupler may be a male connector and the electronic device may have a corresponding female connector. According to one embodiment, the male connector may include a flange, and when the speaker ear piece unit is coupled with the electronic device, the flange is fitted into a depression in the corresponding female connector of the electronic device. According to one embodiment, the male connector may have a pair of laterally extended protrusions, and when the speaker ear piece unit is coupled with the electronic device, the protrusions are fitted under a clamp collar in the corresponding female connector of the electronic device.

According to one embodiment, the retractable speaker ear piece unit may further include a push switch, and an audio input function of the speaker ear piece may be switched to “enabled” while the push switch is pushed, and the audio input function of the speaker ear piece may be switched to “disabled” while the push switch is released.

The present invention further provides a phone watch comprising: a watchcase; and a retractable speaker ear piece unit, the retractable speaker ear piece unit comprising: a housing positioned in the watchcase; a speaker ear piece positioned outside the watchcase; a retractable cord mechanism accommodated in the housing; and a cord, connecting the speaker ear piece and the retractable cord mechanism, which may be extended from or retracted to the retractable cord mechanism.

According to one embodiment, the retractable speaker ear piece unit may include a microphone device embedded in the housing. Moreover, the watchcase and the housing may each have a sound pickup hole. These two holes, which are located correspondingly, cooperate with each other. The internal microphone device cooperates with the holes, so that the retractable speaker ear piece unit can also be used as a phone in a call.

The present invention further provides a phone watch comprising: a watchcase; and a retractable speaker ear piece unit, the retractable speaker ear piece unit comprising: a speaker ear piece positioned outside the watchcase; a retractable cord mechanism accommodated in the housing; and a cord, connecting the speaker ear piece and the retractable cord mechanism, which may be extended from or retracted to the retractable cord mechanism.

According to one embodiment, the phone watch may further include a microphone device embedded in the watchcase. The watchcase may have a sound pickup hole. The internal microphone device cooperates with the hole, so that the retractable speaker ear piece unit can also be used as a phone in a call.

The phone watch may further include a switching means in response to the extension or retraction of the cord. The switching means gets through the phone call for the phone watch when the cord is extended, and disconnects the phone call for the phone watch when the cord is retracted.

According to one embodiment, the retractable cord mechanism may include a resilient element coupling with the cord. According to one embodiment, the speaker ear piece may include projections to enable the speaker ear piece be held between the user's two fingers. According to one embodiment, the speaker ear piece can be discoid speaker ear piece. According to one embodiment, one end of the cord of the speaker ear piece is tied to the center of the “disc”, and the other end is tied to the watch through the retractable cord mechanism.

According to one embodiment, the speaker ear piece unit may further include a circular or elliptic ring extending outward from the speaker ear piece. Alternatively, the speaker ear piece may further include a flexible ring extending outward from the speaker ear piece.

The present invention further provides a phone watch comprising: a watchcase; and a retractable speaker ear piece unit detachably coupled with the watchcase, the retractable speaker ear piece unit comprising: a housing; a speaker ear piece positioned outside the housing; a retractable cord mechanism accommodated in the housing; a cord, connecting the speaker ear piece unit and the retractable cord mechanism, which may be extended from or retracted to the retractable cord mechanism; and a coupler positioned outside the housing for detachably coupling with the watchcase to establish a connection between the speaker ear piece unit and the watchcase.

The phone watch may further include a switching means in response to the extension or retraction of the cord. The switching means disconnects the phone call for the phone watch when the cord is retracted. According to one embodiment, the retractable cord mechanism may include a resilient element coupled with the cord. According to one embodiment, the coupler may include metal contactors and an elastic press switch. When the coupler is coupled with the watchcase, the metal contactors are contacted and the elastic press switch is pressed, so as to establish the electric connection between the watchcase and the speaker ear piece.

According to one embodiment, the coupler may be a male connector and the watchcase may have a corresponding female connector. According to one embodiment, the male connector may include a flange, and when the speaker ear piece unit is coupled with the electronic device, the flange may be fitted into a depression in the corresponding female connector of the electronic device. According to one embodiment the male connector has a pair of laterally extended protrusions, and when the speaker ear piece unit is coupled with the electronic device, the protrusions are fitted under a clamp collar in the corresponding female connector of the electronic device.

The retractable speaker ear piece unit may further include a switching means in response to the extension or retraction of the cord. The switching means gets through the phone call for the phone watch when the cord is extended, and disconnects the phone call for the phone watch when the cord is retracted.

According to one embodiment, the retractable speaker ear piece unit may further include a push switch, and an audio input function of the speaker ear piece is switched to “enabled” while the push switch is pushed, and the audio input function of the speaker ear piece is switched to “disabled” while the push switch is released.

According to one embodiment, the shape of the housing includes cube, cuboid, cylinder, cone, pyramid, prismoid, sphere, hemisphere, ellipsoid, semiellipsoid or combination thereof. But the present invention is not so limited.

According to one embodiment, the retractable speaker ear piece unit may further include a microphone device embedded in the housing. The housing may further have a sound pickup hole. The internal microphone device cooperates with the hole, so that the retractable speaker ear piece unit can also be used as a phone in a call. The location, number and size of the hole described above can be designed to cooperate with the internally embedded microphone devices. However, the present invention is not limited in this aspect.

In accordance with the present invention, the retractable speaker ear piece unit and the phone watch containing the retractable speaker ear piece unit is simple in structure. At normal status, the cord of the ear piece is retracted into the unit for aesthetic and faddish purpose; when receiving a phone call, what one should do is only to extend the cord of the ear piece, so there is no need for Bluetooth ear piece or additionally attached ear piece while the privacy for communication is still ensured. When the phone call is over, the cord is retracted upon releasing the ear piece, which is simple and convenient. In addition, the retractable speaker ear piece unit of the present invention can easily turn into a module of the phone watch that can be easily replaced and maintained.

### DESCRIPTION OF THE DRAWINGS

The present invention will be better understood by referring to illustration of embodiments thereof, in which:

FIG. 1 shows front and back perspective views of the speaker ear piece unit in accordance with the present invention.

FIG. 2 shows explosive views of the speaker ear piece unit in accordance with the present invention.

FIG. 3 shows one embodiment of the phone watch with the discoid speaker ear piece pulled out.

FIG. 4 shows several embodiments of the phone watch provided with the speaker ear piece unit according to the present invention.

### DETAILED EMBODIMENTS

In the description below, for the purposes of explanation, numerous specific details are set forth in order to provide a thorough understanding of the present invention. It will be apparent, however, to those skilled in the art that the present Invention may be practiced without some of these specific details. In other instances, the particular illustrated example embodiments are not provided to limit the present invention but merely to illustrate it. Thus, the scope of the present invention is not to be determined by the specific embodiments provided above but only by the plain language of the appended claims.

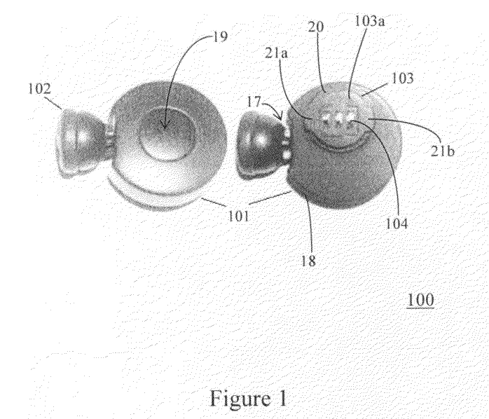

First referring to FIG. 1, FIG. 1 shows front and back perspective views of the speaker ear piece unit 100 in accordance with the present invention. As shown in FIG. 1, the speaker ear piece unit 100 includes a housing 101 and a speaker ear piece 102. The speaker ear piece 102 has a cord (not shown) accommodated in the housing 101, and an ear piece shell positioned outside of the housing 101. At the front (left) of the housing 101, there may be a button 19 (push switch) protruded from the housing, and an audio input function of the speaker ear piece 102 is switched to “enabled” while the button 19 is pushed, and the audio input function of the speaker ear piece 102 is switched to “disabled” while the button 19 is released.

The speaker ear piece unit 100 further includes a retractable cord mechanism (inside the housing 101), so that a cord of the speaker ear piece 102 may be received in the cord mechanism in an extendable and retractable manner. Preferably, the retractable cord mechanism may achieve the retraction of the cord by a resilient element (such as a spring).

The retractable speaker ear piece unit 100 may further include a microphone device (not shown) embedded in the housing. Moreover, the housing may have a pickup hole 18 to pick up sounds. The internal microphone device cooperates with the hole 18, so that the retractable speaker ear piece unit can also be used as a phone in the call. Those skilled in the art will understand that the number of the holes are not limited to one.

Those skilled in the art will understand that the retractable cord mechanism may have a same structure as the retractable cord receiving mechanisms available from current household appliances (for example, receiving mechanism for vacuum sweeper's power cord), but the present invention is not so limited, other variations may occur to those skilled in the art, and these variations fall into the scope of the present invention.

While being used, the speaker ear piece 102 may extend over a user's hand and between two fingers so that it may be held temporarily by these two fingers or in a cupped hand position for listening purpose. Preferably, projections may be disposed on the speaker ear piece 102 to enable the user to hold the speaker ear piece 102 temporarily at some position between these two fingers.

The retractable speaker ear piece unit 100 can both be disposed in a electronic device (such as phone watch, small radio, MP3, MP4, MINI television, mobile phone, etc.) which is used together with the speaker ear piece unit 100, and be detachably coupled with the electronic device for using purpose. In other words, the housing 101 may be the casing (or part of the casing) of the electronic device. The housing 101 and the casing of the electronic device may be an integrally formed single component or two separable components.

It may be seen from the back perspective view (right) of the speaker ear piece unit 100 in FIG. 1 that there is a coupler 103 positioned outside the housing 101 for coupling with an electronic device used together with the speaker ear piece unit 100, so as to establish a connection between the speaker ear piece unit 100 and the electronic device.

Preferably, the coupler 103 includes metal contactors 104 and an elastic press switch. When the speaker ear piece unit 100 is used with an electronic device, the metal contactors of the coupler 103 are aligned with contact points of a corresponding coupler on the electronic device. When the coupler 103 is aligned and effectively coupled with the electronic device, the metal contactors are contacted by the contact points of the electronic device and the elastic press switch is pressed, so as to establish the connection between the speaker ear piece unit 100 and the electronic device. As shown in FIG. 1, in one embodiment of the present invention, the coupler 103 may have three metal contactors 104 used for a triple-pole connections terminal. Those skilled in the art may understand that the coupler 103 may be of other structure or other number of contactors, and all kinds of variations fall into the scope of the present invention.

In the embodiment described above shown in FIG. 1, the three mental contactor 104 of the coupler 103 correspond to typical triple-pole connections between a headphone (ear piece) and a megaphone (microphone) in order to achieve the function of headphone (ear piece) and a megaphone (microphone) in a call. But the present invention is not so limited. Nevertheless, those skilled in the art will understand that various ways of connection and variety of variations, which can achieve the function described above, will all fall into the scope of the present invention.

Preferably, the coupler 103 of the speaker ear piece unit 100 is a male connector 103a and the electronic device has a corresponding female connector (not shown in the figure). When the speaker ear piece unit 100 is coupled with the electronic device, a flange 20 of the coupler 103 is fitted into a matching depression in the coupler of the electronic device, so as to further improving the coupling between them. In the preferable embodiment, the male connector 103a has a flange 20, and when the speaker ear piece unit 100 is coupled with the electronic device, the flange 20 is fitted into a depression in the corresponding female connector of the electronic device. In another preferable embodiment, the male connector 103 has a pair of laterally extended protrusions 21a, 21b, and when the speaker ear piece unit 100 is coupled to the electronic device, the protrusions 21a, 21b are fitted under a clamp collar (not shown in the figure) in the corresponding female connector of the electronic device.

Nevertheless, those skilled in the art may appreciated that the mechanical coupling between the coupler 103 and the electronic device may be in any manner known in the art, and the present invention is not limited in this aspect.

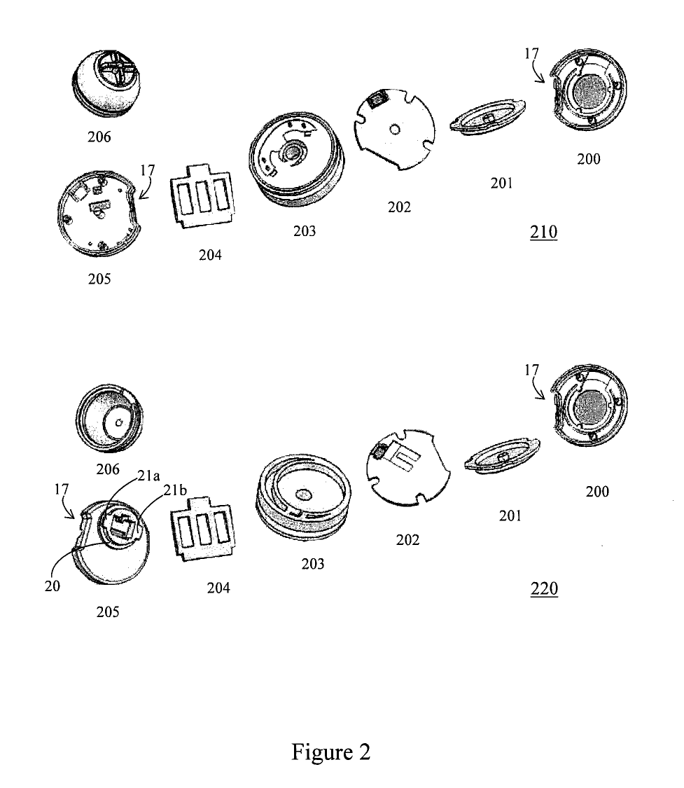

Next, referring to FIG. 2, FIG. 2 describes front explosive view 210 and back explosive view 220 of the speaker ear piece unit. In the middle of the speaker ear piece unit is a retractable cord mechanism 203, which includes a turn plate and an axle hole, and a cord may be received around the turn plate. An upper cover 202 is overlaid on the cord mechanism 203, and a lower cover 204 underneath has three openings for respectively accommodating and separating the three metal contactors 103a on the coupler 103 of the speaker ear piece unit 100.

A switch cap 201 is located on the top of the upper cover, and an upper housing cover 200 is overlaid on the switch cap 201. In the illustrated embodiment, the switch cap 201 is in a round shape, and the upper housing cover 200 has an aperture of a size corresponding to the switch cap 201, which makes the switch cap 201 outstanding of the upper housing cover 200 to form the button 19 at the front of the housing 101, as seen in FIG. 1. Of course, the present invention is not limited in this aspect, and other embodiments may occur to those skilled in the art.

The speaker ear piece unit 100 further includes a lower housing cover 205 surrounding the lower cover 204, and the upper housing cover 200 and the lower housing cover 205 fit with each other to form the complete housing 101 of the speaker ear piece unit 100. The outer surface of the lower housing cover has an aperture to expose the metal contactors (not shown), and there is a flange 20 around the aperture for fitting with the corresponding contact points of the electronic device so as to secure the coupling there between. In one preferred embodiment of the present invention, the flange 20 is formed with a fool-proof structure, for example being approximately circular while having a rectangle in the center, in order to facilitate the aligning and fitting of the couplers of the speaker ear piece unit 100 and the electronic device and avoid plug-in direction error. Of course, the present invention is not limited in this aspect, and other implements may occur to those skilled in the art.

There are notches 17 positioned at side faces of the upper and lower housing cover 200 and 205, and the ear piece case 206 is received in the notch 17 while the speaker ear piece 102 is in a retracted state (referring to FIG. 1).

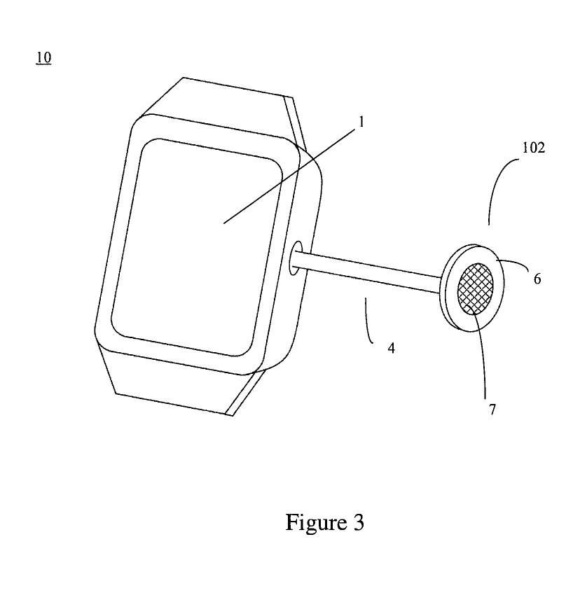

In one embodiment of the present invention (referring to FIG. 3), a phone watch 10 includes a watchcase 1, a retractable speaker ear piece 102, a retractable cord 4 which is coupled between the watchcase 1 and the speaker ear piece 102, and a retractable cord mechanism (not shown). The retractable speaker ear piece 102 extends over a user's hand and between two fingers so that it may be held temporarily by the two fingers or in a cupped hand position for listening purpose.

According to one embodiment, the speaker ear piece 102 and the cord mechanism (not shown) constitute one speaker ear piece unit (not shown). And the speaker ear piece unit may further include a retractable cord 4. Simultaneously, the speaker ear piece unit may further include a housing (not shown), and the watchcase 1 of the phone watch 10 encompasses the housing. The speaker ear piece unit also may not have its own housing. That is to say, the cord mechanism is directly accommodated in the watchcase 1 of the phone watch 10, or the housing of speaker ear piece unit and the watchcase 1 of the phone watch 10 is an integrally formed single component.

In the embodiment described above, the retractable speaker ear piece unit (not shown) may further include a microphone device in the housing. Moreover, the watchcase 1 and the housing (not shown) may each have a sound pickup hole (not shown). These two holes, which are located correspondingly, cooperate with each other. The internal microphone device cooperates with the holes, so that the retractable speaker ear piece unit can also be used as a phone in a call.

Those skilled in the art may understand that the internal microphone device described in the above embodiment can be accommodated in the phone watch 10 as well. Also, there is a hole, in the watchcase 1, cooperates with the internal microphone device. The realization of the internally embedded microphone device itself is known to those skilled in the art, thus, it does not need to give more details. The location, number and size of the hole described above can be designed to cooperate with the internal microphone devices. However, the present invention is not limited in this aspect.

The retractable cord mechanism (not shown) may be accommodated in the phone watch 10. The speaker ear piece 102 may be pulled out or drawn back with the cord by means of the retractable cord mechanism. Preferably, the speaker ear piece 102 can be discoid speaker ear piece. One end of the retractable cord of the discoid speaker ear piece is tied to the center of the “disc”, and the other end is tied to the phone watch 10 through the retractable cord mechanism (or the resilient element in it). Preferably, projections 6 may be disposed on the speaker ear piece 102 to enable the user to hold the speaker ear piece temporarily at some position between two fingers.

The phone watch 10 may include a switching means (not shown) in response to the extension or retraction of the cord. Thus, the switching means gets through the phone call for the phone watch 10, once the cord 4 of the ear piece 102 of the phone watch 10 is extended. By unfolding the fingers, the speaker ear piece 102 is automatically retracted back to the phone watch 10 through the internal retractable cord mechanism, which triggers the switching means to disconnect the phone call.

When receiving a phone call, the discoid speaker ear piece 102 is pulled out from the phone watch over the user's hand and is easily grasped by two fingers on the outer rim or projections 6 located on the speaker ear piece 102. The speaker ear piece 102 may further include a circular or elliptic ring (not shown) extending outward from the speaker ear piece. Alternatively, the speaker ear piece may further include a flexible ring (not shown) extending outward from the speaker ear piece.

The speaker ear piece 102 may be held by two fingers to the user's ear in a cupped hand or extended position for listening purpose. When completing the phone call, the user releases the “disc” by spreading the fingers so as to allow the cord 4 to automatically return to the phone watch 10 and thus disconnects the call.

As it is shown in FIG. 3, the discoid speaker ear piece 102 has been pulled out from the retractable cord mechanism (not shown) with the cord 4. The discoid speaker ear piece 102 includes projections 6 surrounding the speaker 7, which allows the discoid speaker ear piece 102 to be held between two fingers of a hand. The hand can lean on the user's ear with a concave shape, for listening purpose.

When the ear piece 102 is pulled out from the retractable cord mechanism, the phone call of the phone watch is automatically got through. On the contrary, the phone call of the phone watch is automatically disconnected, when the cord 4 of the ear piece 102 is retracted to the inside of the phone watch.

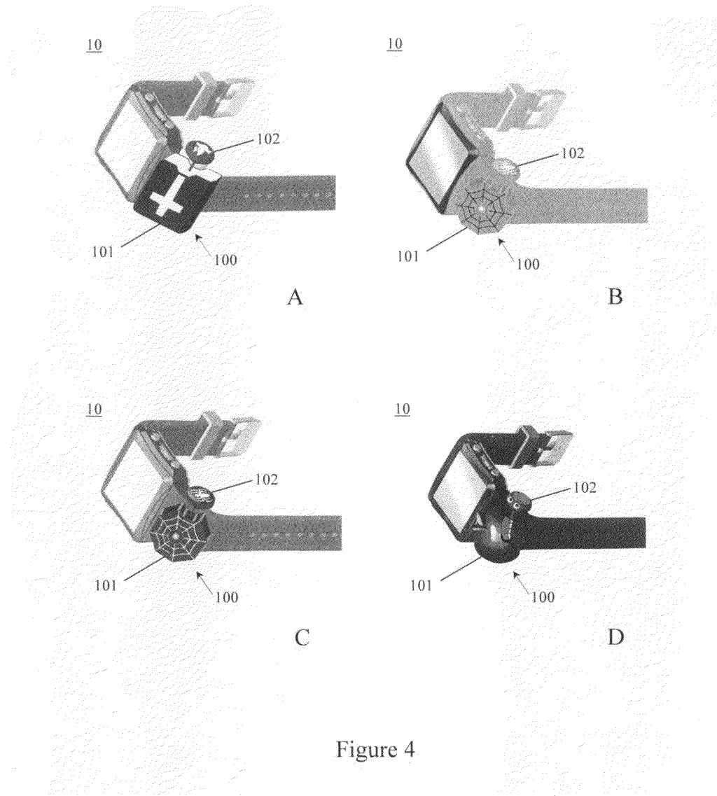

Turning to FIG. 4, FIG. 4 shows several embodiments of the phone watch 10 with the speaker ear piece 102. According to one embodiment, the speaker ear piece unit 100 is detachably coupled with the watchcase. As it is shown in the Figure, the contactors for the ear piece unit 100 can be located on the extended surface of the rim of the phone watch, in order to simplify the wiring between the contactors and the watchcase of the phone watch. Of course, those skilled in the art can understand, the contactors for the speaker ear piece unit may be located on any place of the phone watch, and the speaker ear piece unit may be implemented in various desired shapes and patterns in order to increase the attractiveness of its appearance.

The phone watch 10 may include a switching means (not shown) in response to the extension or retraction of the cord. Thus, the switching means gets through the phone call for the phone watch 10, once the cord of the ear piece 102 of the phone watch 10 is extended. By unfolding the fingers, the speaker ear piece 102 is automatically retracted back through the retractable cord mechanism, which triggers the switching means to disconnect the phone call.

Those skilled in the art will understand that the switching means in accordance with the present invention may be of contact or non-contact type, such as being embodied by IR sensors, friction sensors and the like. However, the present invention is not so limited and those skilled in the art may come up with other variations, which still fall into the scope of the present invention.

When receiving a phone call, the speaker ear piece is pulled out from the phone watch and is easily grasped by two finger digits on the outer rim or projections located on the speaker ear piece. The speaker ear piece 102 may further include a circular or elliptic ring (not shown) extending outward from the speaker ear piece. Alternatively, the speaker ear piece may further include a flexible ring (not shown) extending outward from the speaker ear piece.

The speaker ear piece may be held by two fingers in a cupped hand position or the position between these two fingers, for listening purpose. When completing the phone call, the user releases the “disc” by spreading the fingers so as to allow the cord automatically return to the speaker ear piece 102, and thus disconnects the call.

When the speaker ear piece fails due to frequent use, for example, the retractable cord mechanism loses automatic retracting function, the speaker ear piece loses the capability of propagating audio signals and the like, or the user desires to replace with another speaker ear piece with a different appearance (such as a spider web shape, an apple shape or others as shown in FIG. 4), what shall be done is only to detach the original speaker ear piece module (unit) from the phone watch and plug-in a new module (unit), which is convenient, quick and simple in operation.

Although several exemplary embodiments have been described in detail above, the embodiments described are exemplary only and are not limiting, and those skilled in the art will readily appreciate that many other modifications, changes, and/or substitutions are possible in the exemplary embodiments without materially departing from the novel teachings and advantages of the present disclosure. Accordingly, all such modifications, changes, and/or substitutions are defined in the appended claims.

I claim:

1. A retractable speaker ear piece unit, for using in an electronic device, the retractable speaker ear piece unit comprising:
a housing;
a speaker ear piece positioned outside the housing;
a retractable cord mechanism accommodated in the housing; and
a cord, connecting the speaker ear piece and the retractable cord mechanism, which may be extended from or retracted to the retractable cord mechanism.

2. The retractable speaker ear piece unit of claim 1, wherein the retractable cord mechanism comprises a resilient element coupled to the cord.

3. The retractable speaker ear piece unit of claim 1, wherein the housing is a casing of the electronic device.

4. The retractable speaker ear piece unit of claim 1, wherein a casing of the electronic device encompasses the housing.

5. The retractable speaker ear piece unit of claim 1, further comprising a microphone device embedded in the housing, wherein the housing further comprises a sound pickup hole.

6. The retractable speaker ear piece unit of claim 1, further comprising a coupler positioned outside the housing for detachably coupling with the electronic device to establish a connection between the speaker ear piece unit and the electronic device.

7. The retractable speaker ear piece unit of claim 6, wherein the coupler comprises metal contactors and an elastic press switch, and when the coupler is coupled with the electronic device, the metal contactors are contacted and the elastic press switch is pressed, so as to establish the connection between the speaker ear piece and the electronic device.

8. The retractable speaker ear piece unit of claim 6, wherein the coupler is a male connector and the electronic device has a corresponding female connector.

9. The retractable speaker ear piece unit of claim 8, wherein the male connector has a flange, and when the speaker ear piece unit is coupled to the electronic device, the flange is fitted into a depression in the corresponding female connector of the electronic device.

10. The retractable speaker ear piece unit of claim 8, wherein the male connector has a pair of protrusions, and when the speaker ear piece unit is coupled to the electronic device, the protrusions are fitted under a clamp collar in the corresponding female connector of the electronic device.

11. A phone watch, comprising:
a watchcase; and
a retractable speaker ear piece unit, comprising:
a housing positioned in the watchcase;
a speaker ear piece positioned outside the watchcase;
a retractable cord mechanism accommodated in the housing; and
a cord, connecting the speaker ear piece and the retractable cord mechanism, which may be extended from or retracted to the retractable cord mechanism.

12. The phone watch of claim 11, wherein the retractable speaker ear piece unit further comprises a microphone device embedded in the housing, wherein each of the watchcase and the housing further comprise a respective sound pickup hole correspondingly.

13. A phone watch, comprising:
a watchcase; and
a retractable speaker ear piece unit, comprising:
a speaker ear piece positioned outside the watchcase;
a retractable cord mechanism accommodated in the housing; and
a cord, connecting the speaker ear piece and the retractable cord mechanism, which may be extended from or retracted to the retractable cord mechanism.

14. The phone watch of claim 13, further comprising a microphone device embedded in the watchcase, wherein the watchcase further comprises a sound pickup hole.

15. The phone watch of claim 11, further comprising a switching means in response to the extension or retraction of the cord, wherein the switching means disconnects the phone call for the phone watch when the cord is retracted.

16. The phone watch of claim 11, wherein the retractable cord mechanism comprises a resilient element coupled to the cord.

17. A phone watch, comprising:
a watchcase; and
a retractable speaker ear piece unit detachably coupled with the watchcase, the retractable speaker ear piece unit comprising:
a housing;
a speaker ear piece positioned outside the housing;
a retractable cord mechanism accommodated in the housing;
a cord, connecting the speaker ear piece unit and the retractable cord mechanism, which may be extended from or retracted to the retractable cord mechanism; and
a coupler positioned outside the housing for detachably coupling with the watchcase to establish a connection between the speaker ear piece unit and the watchcase.

18. The phone watch of claim 17, further comprising a switching means in response to the extension or retraction of the cord, wherein the switching means disconnects the phone call for the phone watch when the cord is retracted.

19. The phone watch of claim 17, wherein the retractable cord mechanism comprises a resilient element coupled to the cord.

20. The phone watch of claim 17, wherein the coupler comprises metal contactors and an elastic press switch, and when the coupler is coupled with the watchcase, the metal contactors are contacted and the elastic press switch is pressed, so as to establish the connection between the speaker ear piece and the watchcase.

21. The phone watch of claim 17, wherein the coupler is a male connector and the watchcase has a corresponding female connector.

22. The phone watch of claim 17, wherein the male connector has a flange, and when the speaker ear piece unit is coupled to the electronic device, the flange is fitted into a depression in the corresponding female connector of the electronic device.

23. The phone watch of claim 22, wherein the male connector has a pair of laterally extended protrusions, and when the speaker ear piece unit is coupled to the electronic device, the protrusions are fitted under a clamp collar in the corresponding female connector of the electronic device.

24. The phone watch of claim 17, wherein the retractable speaker ear piece unit further comprises a switching means in response to the extension or retraction of the cord, wherein the switching means gets through the phone call for the phone watch when the cord is extended, and disconnects the phone call for the phone watch when the cord is retracted.

25. The phone watch of claim 17, wherein the retractable speaker ear piece unit further comprises a push switch, and wherein an audio input function of the speaker ear piece is switched to “enabled” while the push switch is pushed, and the audio input function of the speaker ear piece is switched to “disabled” while the push switch is released.

26. The phone watch of claim 17, wherein the retractable speaker ear piece unit further comprises a microphone device embedded in the housing, wherein the housing further comprises a sound pickup hole.

27. The phone watch of claim 17, wherein the shape of the housing comprises cube, cuboid, cylinder, cone, pyramid, prismoid, sphere, hemisphere, ellipsoid, semiellipsoid or combination thereof.

28. The phone watch of claim 13, further comprising a switching means in response to the extension or retraction of the cord, wherein the switching means disconnects the phone call for the phone watch when the cord is retracted.

29. The phone watch of claim 13, wherein the retractable cord mechanism comprises a resilient element coupled to the cord.
